(19) United States
(12) Patent Application Publication
(10) Pub. No.: US 2005/0239367 A1
(43) Pub. Date: Oct. 27, 2005

(54) Combined portable fan-candy holder toy

(76) Inventor: Rodolfo Fernandez JR., Kings Mountain, NC (US)

Correspondence Address: RODOLFO FERNANDEZ JR., 308 FULTON STREET, KINGS MOUNTAIN, NC, 28086, US

(21) Appl. No.: 10/828,561

(22) Filed: Apr. 21, 2004

(51) Int. Cl. A23G 1/00; A63H 17/12

(52) U.S. Cl. 446/73; 446/425

(57) ABSTRACT

A combined portable fan-candy holder toy, which comprises any kind of portable fan built in a great variety of shapes, which can be provided with light of any color and/or sound emitting elements, and which is combined with one or more candy holding devices of female or male type, to hold lollipops and other confectioneries provided with solid or hollow sticks or to attach common candies provided with appropriate holes, so that the user enjoys a fresh and pleasant breeze while consuming the candy and said candy holding device, in turn, can be provided with different kind of motions by means of mechanisms driven by hand or conveniently linked to the fan motor, including slight pleasant vibrations due to the high speed rotation of conveniently unbalanced elements.

| D396,104 | July 1998 | Radtke | D23/379 |
|---|---|---|---|
| 5,855,500 | January 1999 | Coleman et al | 446/81 |
| D406,331 | March 1999 | Chan | D23/382 |
| 6,077,144 | June 2000 | Fishman | 446/236 |
| 6,155,782 | December 2000 | Hsu | 416/63 |
| 6,109,874 | August 2000 | Steiner et al | 416/63 |
| 6,179,564B1 | January 2001 | Park | 416/63 |
| 6,192,702B1 | February 2001 | Shimogori | 62/259.3 |
| 6,200,189B1 | March 2001 | Coleman et al | 446/298 |
| 6,217,294B1 | April 2001 | Arnieri et al | 417/239 |
| 6,227,929B1 | May 2001 | Nelson et al | 446/239 |
| D451,991S | December 2001 | Israel et al | D23/377 |
| 6,398,132B1 | June 2002 | Junkel et al | 239/289 |
| 6,378,845B1 | April 2002 | Hsu | 261/28 |
| 2003/0068412A1 | April 2003 | Coleman et al | 426/134 |
| 6,645,030B2 | November 2003 | Coleman et al | 446/73 |
| 2003/0228827A1 | December 2003 | Coleman et al | 446/236 |

### CROSS REFERENCE TO RELATED APPLICATIONS

(Not Applicable)

### STATEMENT REGARDING FED. SPONSORED R & D

(Not Applicable)

### REFERENCE TO SEQUENCE LISTING

(Not Applicable)

### BACKGROUND OF THE INVENTION

In their simple basic form, lollipops have been known for a long time, and many different inventions have been developed regarding this type of candy. The lollipop consumption has been growing year after year, and at the same time, their fields of use have been diversified, including pharmaceutical products and other edible confectioneries and toys.

At the same time, during many years, a great variety of portable fans have been developed to refresh and amuse the user.

However, despite the numerous innovations and devices related to lollipops and portable fans, until now, a satisfactory and advantageous combination of both has not been created. The innovative combination object of the present invention, provides the user the opportunity of simultaneously enjoying the pleasant taste of the candy with the refreshing breeze coming from easy to hold portable fans, converted to reusable or disposable candy holders, by means of appropriate designs, and, as an special and additional feature, takes advantage of the vibration effect transmitted to the held candy by the high speed rotating air impellers slightly unbalanced.

Many patents have been issued for improvements and novelties, and a great variety of designs has been introduced in the field of candy or lollipop holders, but according to our search, those patents have been always related to holders featuring different kind of motion, including rotating elements as decorative options and/or sound and/or luminous patterns, and also many patents have been issued to different portable fans inventions and designs, without considering as alternative to attach candies to said fans, but in none of them has been considered the comprehensive and specific direct relation between both fields object of the present invention.

Despite the fact that there are many patents issued to a great variety of portable fans, and there are also many patented inventions of candy or lollipop holders, where candies are attached to a holding toy providing all kinds of motion, illumination, sound or combinations of these features, it has not been claimed the option of combining candy holders and portable fans, which is the main object of the present invention.

### BRIEF SUMMARY OF THE INVENTION

This invention relates to the combination of portable fans with candy holders and, particularly, to lollipops supported by appropriate holding elements conveniently mounted to the portable fan, which, in turn, can be similar to prior art types or configured as novel designs. The candy also can be similar to well known lollipops provided with the usual stick, or just candies without stick, properly configured to replace others previously consumed.

The present invention, wherein the candies are attached to a portable fan, constitutes the creation of a new kind of portable fan and lollipop or candy holder, which allows the consumer to enjoy the consumption of the candy and, at the same time, the pleasant refreshing breeze from the portable fan-candy holder, increasing his/her pleasure, especially during the hot summertime days, and in warm climate zones.

The combined portable fan-candy holder toys object of the present invention may be configured in many different shapes and powered either manually, mechanically, by pneumatic energy or by any convenient type of battery. As prior art portable fans, they can be provided with rigid blades covered by protecting guards, or with soft and flexible exposed blades.

Another object of the present invention is the creation of portable fans with either simple or complex candy holders, as an integrated component, made of nontoxic plastics, or any suitable material, which can be either disposable or reusable, and providing optional motion features to make lollipops and candies, as well as portable fans, more attractive and pleasant to consumers.

An additional object of the present invention is to increase the user's pleasure and the lollipop appeal, promoting the design of many different and attractive configurations and fan-candy combinations, including the use of miniature electronic devices to emit sounds and/or light, which can be inserted in different components of the portable fan-candy holder.

Furthermore, as a result of slightly unbalanced air impellers rotating at relatively high speed, the held candies are subjected to a vibration motion that adds fun to its consumption.

Depending upon its simplicity and cost, the combined portable fan-candy holder toys could be disposable, for very cheap and short duration types, or reusable, for more sophisticated and expensive models.

The candies, in turn, can be like common lollipops, provided with solid cylindrical sticks, or hollow cylindrical or conical sticks, or simple stick free candies properly configured to be attached to the holding device of the portable fan-candy holder.

As an optional feature, the portable fan-candy holder object of the present invention can be provided either with an integrated section, or a separate attachment, conveniently conformed to allow keeping it in a stable position on a supporting surface.

These features and advantages, and some others, will become evident to those skilled in the art through the drawings and their descriptions illustrating the present invention.

### BRIEF DESCRIPTION OF THE DRAWINGS

FIG. 1 illustrates a general view with a partial axial section of a simple embodiment of the portable fan-candy holder object of the present invention comprising a common portable fan modified with a holding attachment to hold a common lollipop.

FIG. 2 illustrates an elevation partially sectioned view of another embodiment of the present invention and its components, comprising a common portable fan with a holding attachment to hold a common lollipop, provided with a light emission device and waving optical fibers.

FIG. 3 illustrates a partial section view of an alternate embodiment of the invention in which the fan motor with its shaft protruding from both sides is mounted by its shaft with one end fixed coupled to a flexible tubular element above the handle, and the air impeller is mounted on the outer motor body, which rotates around its fixed shaft, while the candy holding device is coupled to the other end of the fixed shaft.

FIG. 4 comprises two views FIGS. 4A and 4B, illustrating section views of an alternate embodiment of the combined portable fan-candy holder toy, provided with a mechanism to provide rotation and oscillation to the fan horizontally positioned, in front of which a common lollipop is held on an elastic attachment.

FIG. 5 illustrates an external view of an alternate embodiment of the combined portable fan-candy holder toy, with the fan air impeller axially sectioned, mounted on the shaft of a miniature battery motor, oriented almost horizontally, and conveniently unbalanced to produce the vibration of a lollipop mounted into a holding attachment, rapidly hitting a second lollipop mounted into another holding attachment at a convenient angle, producing a clapping sound, and with a light emission element installed on the fan air impeller, to produce a circular luminous pattern when it rotates.

FIG. 6 comprises two views: FIGS. 6A and 6B, illustrating an axial section and a detail section views, of another possible embodiment of the combined portable fan-candy holder toy, provided with flexible fan blades and a mechanism to produce the axial oscillation of the lollipop mounted to an axially movable holding device.

FIG. 7 illustrates an axial section view of other alternate possible embodiment of the combined portable fan-candy holder toy, mounted on top of a beverage reservoir.

FIG. 8 illustrates an external view of an alternate embodiment of the combined portable fan-candy holder toy with the configuration of a wineglass.

FIG. 9 comprises two views: FIGS. 9A and 9B, illustrating partial axial section and upper section views of another possible embodiment of the combined portable fan-candy holder toy object of the present invention, provided with a mechanism to rotate the lollipop mounted to the holding device, and, at the same time, rotating the air impeller around the axis of the holder.

FIG. 10 illustrates a partial axial section view of a possible embodiment of the combined portable fan-candy holder toy, with two air impellers mounted in a planetary mechanism to make them rotate around the axis of the candy holding device.

FIG. 11 illustrates an external view of an alternate embodiment of the present invention with two free wheel fan blades rotating in opposite directions by the action of the air stream supplied by the portable fan, and with light emission elements located at the tips of the free wheel fan blades, to produce circular light patterns, while the candy mounted onto the holding device does not rotate, but it vibrates slightly under the effect of the unbalanced rotating components.

FIG. 12 illustrates an external and axial section view of another alternate embodiment of the combined portable fan-candy holder toy in which the portable fan is of a low profile and can be encased into a stable base, to be placed on a flat surface, while the holding device has the configuration of an articulated character with its legs inserted on the upper cover of the portable fan, and is provided with a cloak that waves under the effect of the air stream produced by the fan below, while its both hands are conveniently adapted to hold common lollipops at variable angles, and in the place of the eyes there are light emission elements.

FIG. 13 comprises three views: FIGS. 13A through 13C, illustrating different views of another alternate embodiment of the combined portable fan-candy holder toy with the configuration of a figure resembling an astronaut with back rockets and light emission elements, in which the fan air impeller is located above the head of the figure, while a lollipop is inserted into a holding device located on the upper side of the simulated back rockets.

FIG. 14 illustrates an external view of an alternate embodiment of the present invention with a basic configuration similar to that shown in FIG. 8, with several articulated movable figures resembling animal characters, which can be moved manually by the user, pushing any of the figures or shaking the combined portable fan-candy holder toy.

FIG. 15 comprises two partially sectioned views: FIGS. 15A and 15B, illustrating another alternate embodiment of the present invention resembling an airplane with two fan propellers driven by belts and pulleys, provided with light emission elements and with a male holding device protruding from the front end, properly configured to hold replaceable candies.

FIG. 16 comprises four views: FIGS. 17A through 17D, illustrating several views of different alternate devices that can be used as candy holding devices for combined portable fan-candy holder toy embodiments.

FIG. 17 comprises five views: FIGS. 17A through 17E, illustrating several views of some different configurations of lollipops, lollipops sticks and candy holding devices for the portable fan-candy holder object of the present invention.

### DETAILED DESCRIPTION OF THE INVENTION

The combined portable fan-candy holder toy, object of the present invention comprises three basic components and can have as many supplementary components as desired. The three basic components are: a portable fan with one or more air impellers, one or more candy holding attachments and one or more lollipops or candies.

Each one of all three basic components can be very similar to known prior art, being the combination of them what constitutes the innovative aspect of the present invention.

The combined portable fan-candy holder toy, as an additional option to increase its amusement features, can be provided with an integrated section, or a separate attachment, properly conformed to encase a battery powered miniature electronic device unit, which is automatically activated whenever the combined portable fan-candy holder toy is touched or moved by the user, or by any other adequate means, to play a pleasant melody and/or to emit colored continuous or blinking lights during a period of time.

In the case of light emission, the holding device, and other components of the combined portable fan-candy holder toy may be made of translucent material, and with appropriate external surface to behave like an optical fiber, to conduct the light emitted by the electronic device to the interior of the candies, through hollow sticks, or can be provided with movable optical fibers which undulate under the action of the air stream producing by the fan.

All components of the present invention, in all their possible variations, can be produced using current manufacturing processes, which allow high rates of production, are highly efficient and reliable, and are very well known in the fields of confectionery and injection molding. At the same time, this toy can be manufactured with the necessary quality control to guarantee the highest standards of safety for the users, who very often are kids.

In the consecutive drawings, the same or equivalent component or parts of components are designated with the same reference character, according to their function rather than to its configuration, since there are a great number of different possible shapes for the same components.

Most main features of the combined portable fan-candy holder toy are explained below in the detailed description of the illustrative drawings, however, the preferred embodiments of the present invention and each of its components may be much different and much more diversified than those shown in the figures.

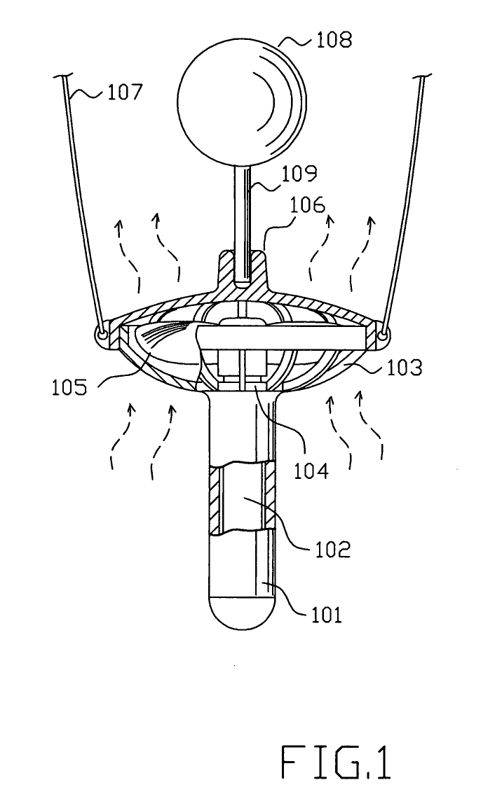

FIG. 1 illustrates a simple preferred embodiment of the combined portable fan-candy holder toy, object of the present invention, comprising a portable fan handle 101, into which are located the battery power source 102, and a miniature electric motor 104. On top of the handle 101, is located a widened chamber or protecting cover 103, inside which rotates an axial air impeller 105 comprising two or more fan blades, mounted to the shaft of the motor 104, which drivers the air impeller 105 when said motor is connected to the power source by any proper means. The portable fan-candy holder toy, as many known portable fans, can be provided with a necklace hanging element, like the string 107 shown in this figure. Above the protecting cover 103, is attached a holding device 106, into which is inserted the stick 109 of a common lollipop candy 108. With the fan activated, the user receives a fresh breeze on his/her face whenever he/she consumes the candy, which, in addition, vibrates as a consequence of the usual or intentional slight unbalance of the fan blades rotating at high speed, increasing the consumer's fun and pleasure.

It is obvious that the combined portable fan-candy holder toy object of the present invention can be greatly varied in composition and configuration, as will be shown in the examples of the next figures.

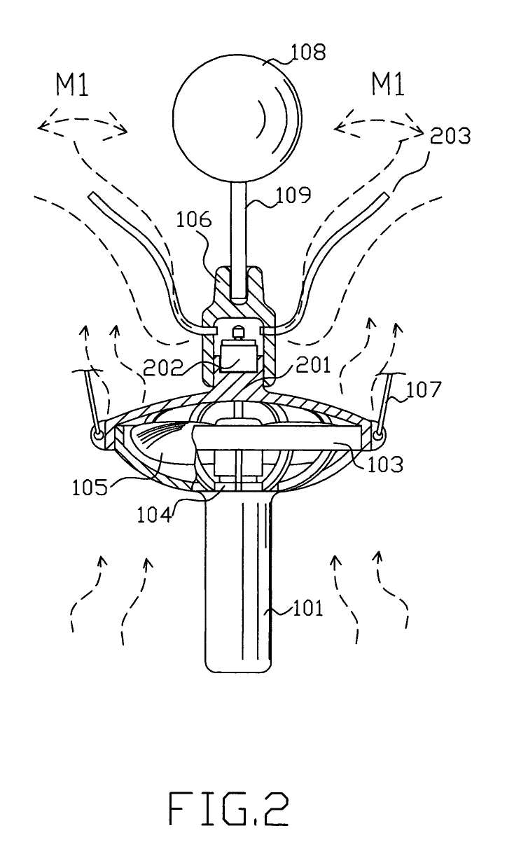

FIG. 2 illustrates a truncated partial view of an alternate embodiment of a combined portable fan-candy holder toy, comprising a portable fan similar to that previously seen in FIG. 1, showing the handle 101, the protecting cover 103, the upper portion of the electric motor 104, the air impeller 105, part of the necklace hanger string 107, and the lollipop candy 108 with its stick 109, inserted into the holding device 106. However, in this embodiment, the upper part of the protecting cover 103 is provided with a protruding element 201, which houses a miniature electronic device for light and/or sound emission 202, powered and activated by any convenient means, covered by the holding device attachment 106 and provided with several flexible optical fibers 203, which undulate under the action of the air stream produced by the fan, as indicated by the arrow M1.

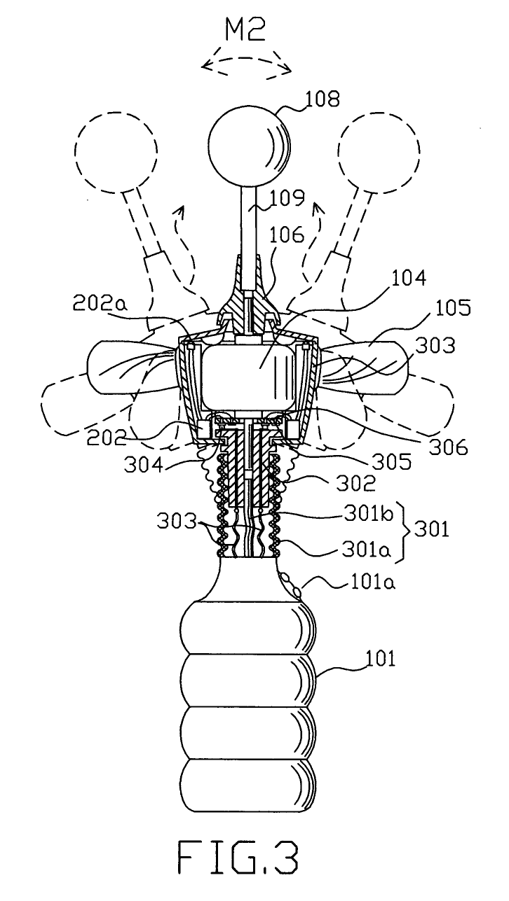

FIG. 3 illustrates an elevation view partially sectioned of an alternate embodiment of combined portable fan-candy holder toy comprising a handle 101, provided with an appropriate power switch 110a, and attached at its top is a flexible coupling neck 301, integrated by a tubular bellow type outer sleeve 301a, and a malleable core 301b. To the upper end of the flexible coupling neck 301 is inserted a support plug 302, provided with an axial bore into whose lower portion is securely inserted the upper end of the malleable core 301b, while into the upper end portion of the plug 302 is securely inserted the lower protruding shaft of the motor 104, such that when switched on, the stator of the motor 104 rotates, while its shaft remains static. The power from the battery source (not shown) housed inside the handle 101, is supplied to the motor through the conductors 303, passing through the support plug 302, and soldered to the fixed contacts 304, securely attached to the upper flange of the support plug 302. From the fixed contacts 304, the power is supplied by friction contact to the rotating stator of the motor 104, through the rotating contacts 305, securely fixed to a non-conductive disk 306, properly attached to the stator of the motor 104, and provided with a central opening through which passes the lower portion of the shaft of said motor 104. The air impeller 105 is securely engaged to the stator of the motor 104, rotating with it, producing a fresh breeze toward the face of the user, and the fan can be oriented toward different directions at different angles as allowed by the flexible coupling neck 301. On top of the air impeller 105 there is a hole through which passes the upper portion of the shaft of the motor 104, to which is securely fixed a holding device 106, into which, in turn, the stick 109 of a lollipop 108 is inserted. When the motor 104 is switched on, the air impeller 105 rotates while the candy does not, but it may vibrate due to the effect of the slightly unbalanced weight of the rotating fan blades of the air impeller 105. The type of fan blades of the air impeller 105 illustrated in this embodiment, are flexible and soft to avoid hurting the user's skin in case of direct contact during its operation. Therefore, they are shown bent downward by dotted lines to illustrate their approximate position when the power is switched off. In this figure, are shown in dotted lines also, two possible lateral positions adopted by the toy if it is inclined bending its flexible coupling neck 301 as indicated by the arrow M2.

Inside the air impeller 105 can be installed miniature battery electronic devices 202, as well as miniature L.E.D.s, to provide amusing light/sound effects during the operation of the fan.

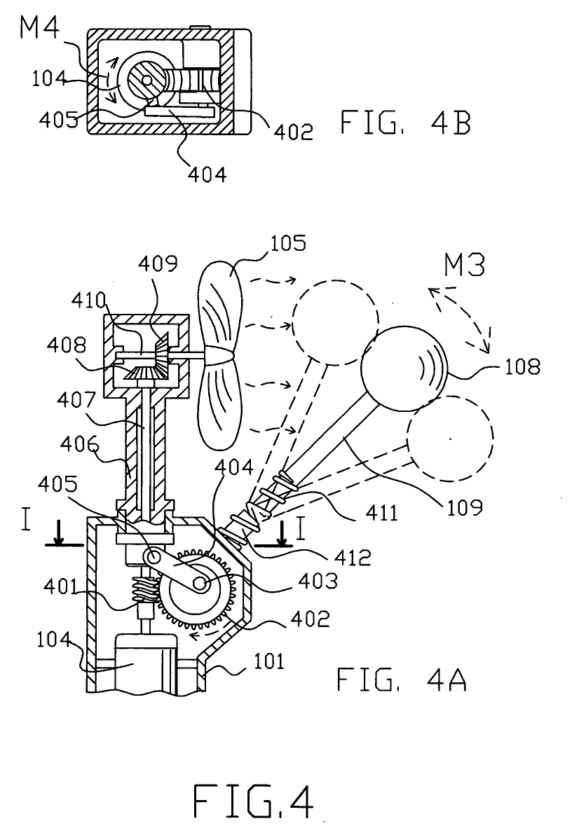

FIG. 4 comprises two views: FIG. 4A illustrating a partial axial section view of another alternate embodiment of the present invention, and FIG. 4B, illustrating a section view through the plane I-I in FIG. 4A. In these figures, is shown the upper portion of the handle 101, housing the miniature electric motor 104, and a mechanism comprising a worm gear 401 mounted on the shaft of the motor 104, engaged to a crown gear 402, provided with an eccentric pivot 403, to which is articulated one end of a connecting rod 404, whose other end is connected to another pivot 405 located at one side of a tubular support 406, which oscillates in relation to the axis of the handle 101, as indicated by the arrow M4, driven by said mechanism, at slow speed, when the motor 104 is activated. At the same time, through the oscillating support 406, passes a shaft 407, directly coupled to the shaft of the motor 104, and provided at its upper end with a conical pinion 408, engaged to another conical pinion 409, transmitting a high speed rotation to the shaft 410, on whose outer end is mounted the air impeller 105. In front of the air impeller 105, is located a lollipop 108, whose stick 109 is inserted into a holding device, comprising a spring 411, coupled to a short stem 412 fixed in turn at a convenient angle to the upper part of the housing handle 101, such that the candy 108 can oscillate elastically as indicated by the arrow M3, adopting different positions illustrated in dotted lines.

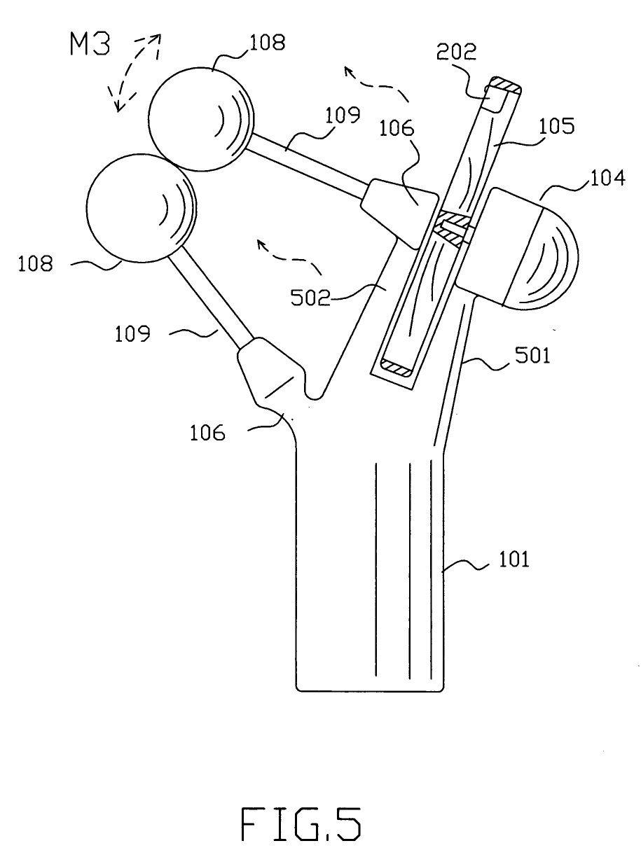

FIG. 5 illustrates an external view of an alternate embodiment of the combined portable fan-candy holder toy, with the air impeller 105 axially sectioned, mounted on the shaft of a motor 104, oriented almost horizontally, supported at the end of an arm 501 protruding from the handle 101, and the fan blades of the air impeller 105 are slightly unbalanced to produce the vibration of a lollipop 108, whose stick 109 is inserted into a holding device 106, aligned in front of the axis of the motor 104, at the end of a second arm 502 made of appropriate resilient plastic, so that said lollipop 108 rapidly oscillates as indicated by the arrow M3, repeatedly hitting a second lollipop 108 mounted into another holding device 106, elastically attached to the handle 101 at a convenient angle, thus producing a clapping sound. The fan blades of the air impeller 105 are provided with a light emission electronic unit 202, to produce a circular luminous pattern when they rotate.

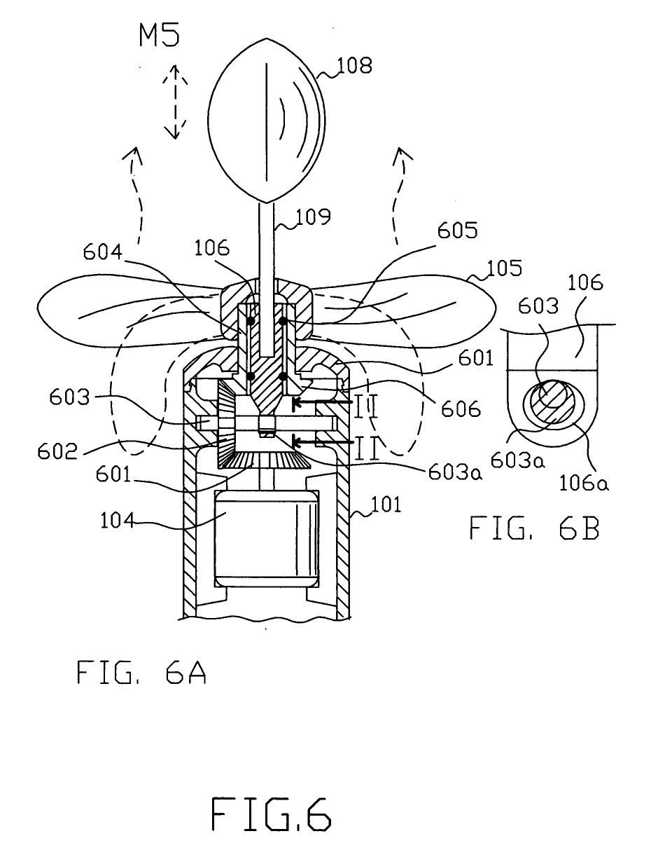

FIG. 6 comprises two views: FIG. 6A, illustrating a partial axial section view and FIG. 6B illustrating a magnified detail section view through the plane II-II in FIG. 6A, of another possible embodiment of the combined portable fan-candy holder toy, showing the motor 104 inside the handle 101, and an air impeller 105 provided with flexible fan blades, which are also shown in dotted lines at resting position, and a mechanism to produce the axial oscillation of the lollipop 108, whose stick 109 is inserted into an axially movable holding device 106. Said mechanism comprises a conical gear 601 attached to the shaft of the motor 104, engaged to a second conical gear 602 fixed to a shaft 603, provided with a small eccentric cam 603a, which rotates inside the hole 106a located at the lower end of the holding device 106, which can move up and down through a hollow shaft 604, sliding on a couple of ring bearings 605. The second conical gear 602 engages with a third conical gear 606 attached at the lower end of the hollow shaft 604, transmitting the motor high speed to the air impeller 105 mounted on the upper end of the hollow shaft 604. The candy 108, whose stick 109 is inserted into the holding device 106, does not rotate, but moves up and down with the holding device 106 as indicated by the arrow M5 and gently vibrates due to the unbalanced air impeller 105.

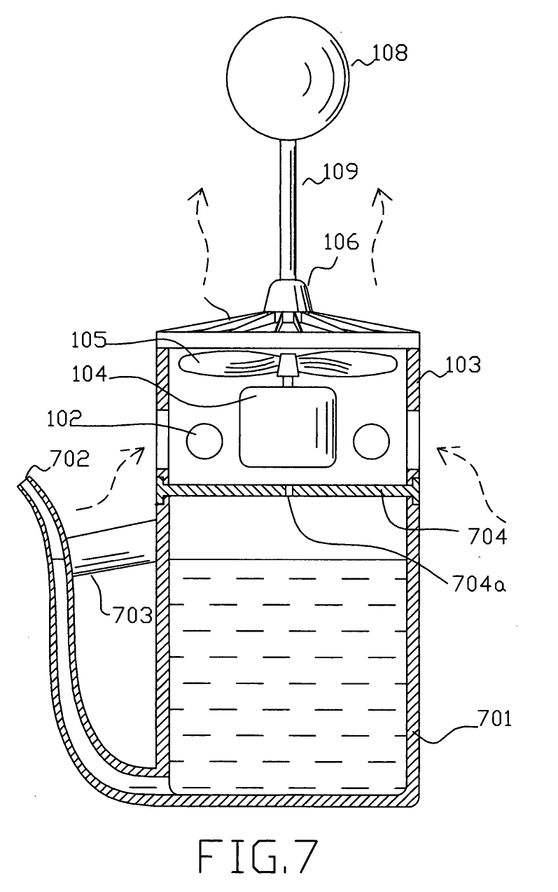

FIG. 7 illustrates an axial section elevation view of other alternate possible embodiment of the combined portable fan-candy holder toy, in which the handle is replaced by a container 701 for any kind of drinkable liquid, provided with a sucking tube 702, held by a support 703. Above the container 701 is mounted the protecting chamber and cover 103 of the portable fan, housing the power batteries 102, the electric motor 104 and the air impeller 105. On top of the fan cover 103, is attached the holding device 106, into which is inserted the stick 109 of a lollipop 108. The lower container 701 and the fan chamber 103 are separated by an intermediate disk 704, which functions either like the fan chamber bottom cover or like the container cover, and is provided with a vent opening 704a.

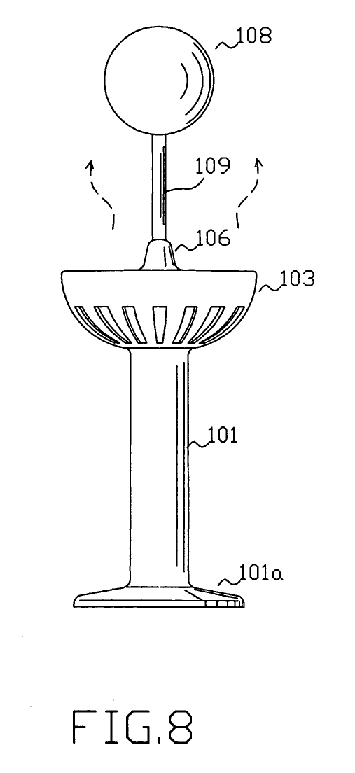

FIG. 8 illustrates an external view of a simple alternate embodiment of the combined portable fan-candy holder toy with the configuration of a wine-glass, showing the handle 101 provided at its lower end with a base 101a and with the air impeller chamber or protecting cover 103 above. On top of the air impeller chamber 103 is located a holding device 106, into which is inserted the stick 109 of a lollipop candy 108.

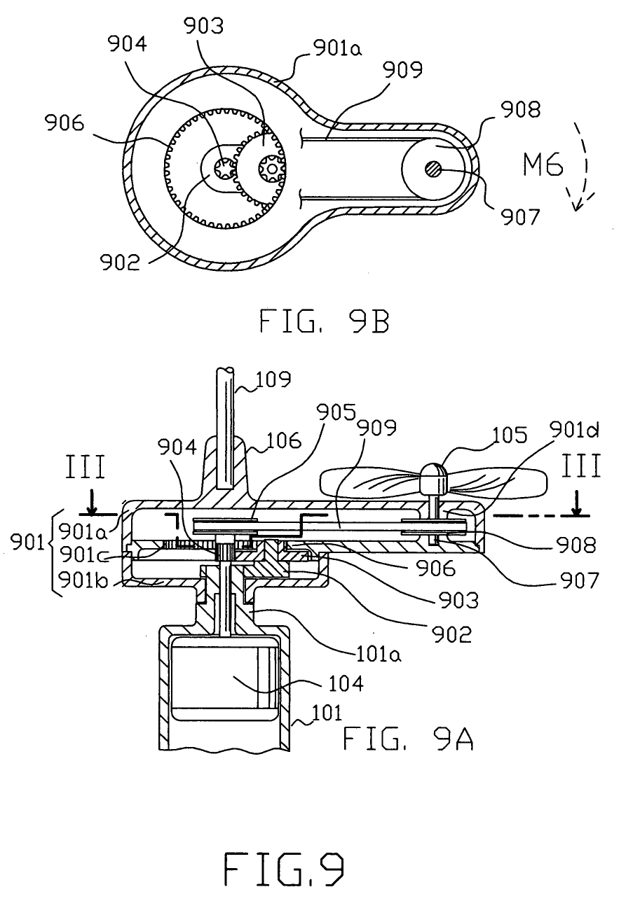

FIG. 9 comprises two views: FIG. 9A, illustrating a partial elevation section view and FIG. 9B, illustrating an upper section view through the plane III-III in FIG. 9A, of another possible embodiment of the combined portable fan-candy holder toy object of the present invention, provided with a mechanism to slowly rotate the lollipop (not shown) whose truncated stick 109 is inserted into the holding device 106, on top of the upper cover 901a, which in turn, also rotate slowly with the outer air impeller 105, around the axis of the toy handle 101, inside which is shown the motor 104. The whole upper chamber 901 housing the mechanism, can rotate around the central axis, because its lower part 901b is loosely fitted to the cylindrical upper end 101a of the handle 101, through whose hollow core, at the same time, the shaft of the motor 104 passes and may rotate freely. Above the lower part of the chamber 901, a support 902 is securely fixed to the upper tip of the cylindrical upper end 101a of the handle 101, and supports a double gear 903 eccentrically located. At the upper end of the shaft of the motor 104, is mounted a central pinion 904, integrated with a driver pulley 905 above. When the motor rotates, the central pinion 904 transmits the rotation to the bigger gear of the gear pair 903, while the smaller and upper gear of said gear pair is engaged to an interior bigger gear 906 integrated with an intermediate section 901c of the chamber 901, which has a portion laterally displaced, and supporting a secondary shaft 907 with a driven pulley 908 securely attached, and connected to the driver pulley 904 by a rubber belt 909. The upper cover 901a of the chamber 901 is provided with an open bearing 901d through which passes the shaft 907 of the driven pulley 908, and at whose outer end is attached the air impeller 105, which rotates at relatively high speed, while the whole chamber rotates at a very low speed in the direction indicated by the arrow M6 around the main axis of the handle 101.

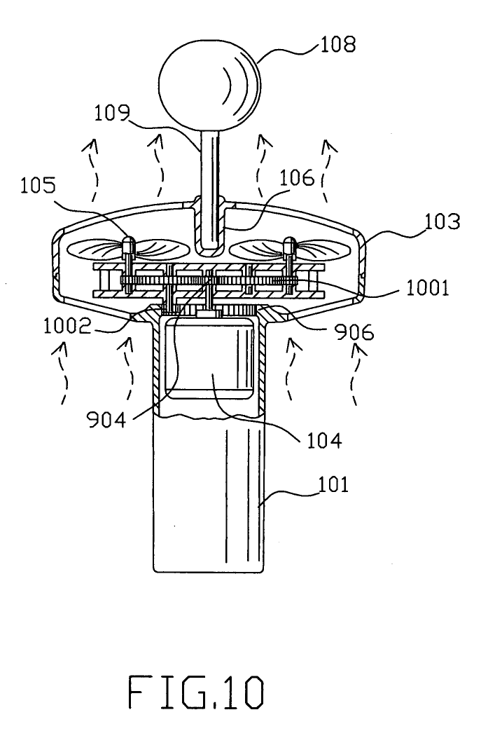

FIG. 10 illustrates a partial axial section view of another alternate possible embodiment of the combined portable fan-candy holder toy, with two axial air impellers 105 mounted on a planetary mechanism 1001 in such a way, that they rotate around the axis of the handle 101, inside which can be seen a motor 104, which in turn drives the planetary mechanism by means of a central pinion 904 attached to the end of the shaft of the motor 104. The whole planetary mechanism 1001 with the air impellers 105, rotates inside the protecting chamber 103, due to the engagement of a pinion 1002 to the inner gear 906 integrated to the lower part of the chamber 103 while a lollipop 108 with its stick 109 remain fixed, inserted into the holding device 106 integrated with the upper cover of the chamber 103.

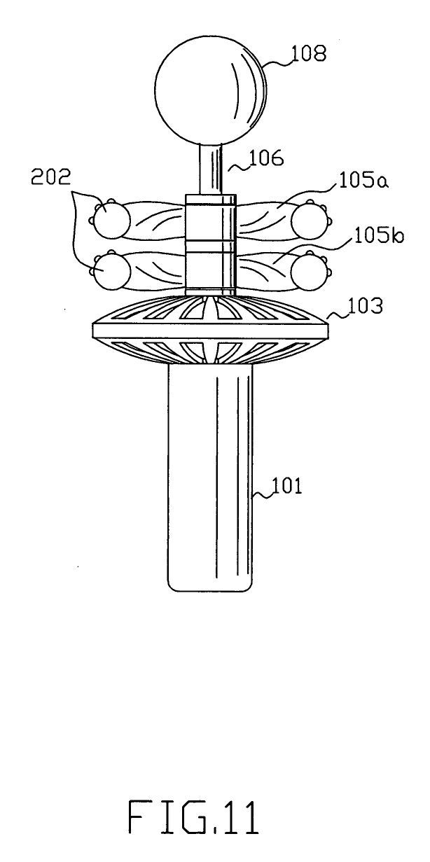

FIG. 11 illustrates an external view of an alternate embodiment of the present invention in which two free wheel fan blades 105a and 105b, conveniently configured, rotate freely in opposite directions by the action of the air stream supplied by the air impeller (not shown) inside the protecting chamber 103 above the handle 101. At the ends of the free rotating fan blades 105a and 105b, there are light and/or sound emitting miniature compact devices 202, integrated with its own power supply and control element. In this embodiment, the candy holding device 106 is a male elongation above the stationary shaft supporting the free rotating fan blades 105a and 105b, and the candy 108 is a simple candy provided with an appropriate assembling hole. The candy 108 does not rotate, although can vibrate slightly due to the oscillation of the conveniently unbalanced rotating elements.

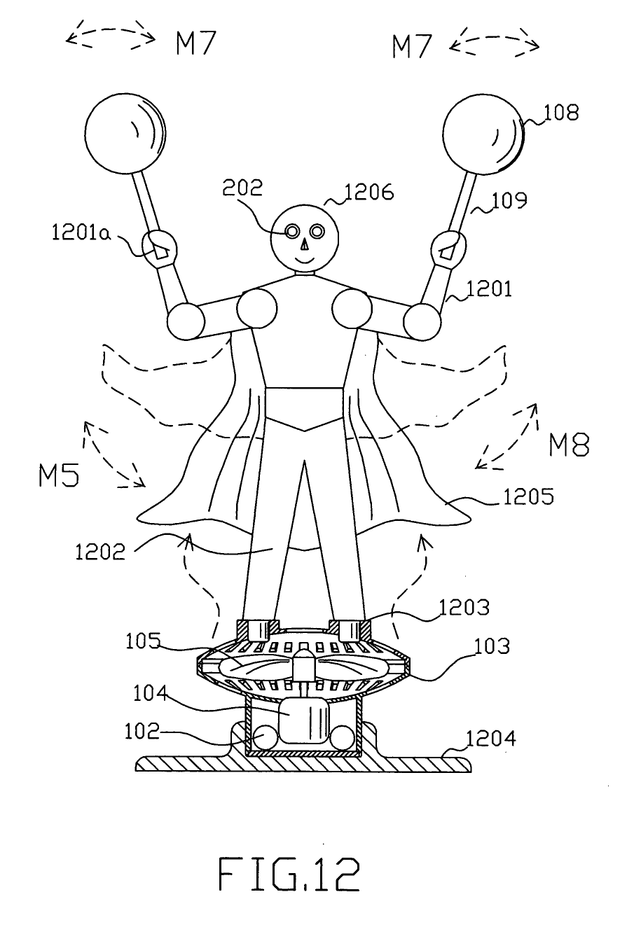

FIG. 12 illustrates an external elevation view of a candy holder configured like an android robot provided with two articulated arms 1201 onto whose hands 1201a can be inserted the sticks 109 of the lollipops 108, at adjustable positions as indicated by the arrow M7. The lower extremities 1202 of the holding figure are inserted into conveniently designed holding supports 1203 located above the upper portion of the protecting cover 103 of a portable fan body of low profile shown in axial section view, inside which can be seen the air impeller 105, the motor 104 and the batteries 102. The body of the portable fan is shown encased into a stable base 1204 conveniently configured to be placed on a supporting surface. The holding character is provided with a flexible fabric cape 1205, which undulates under the action of the air stream produced by the fan under it, as shown in dotted lines and as indicated by the arrow M8. In the head 1206 of the figure are inserted light and/or sound emission devices 202. The candy holding figure can be replaceable and adopt many different configurations, and in the flexible cape can be integrated optical fibers with appropriate light emission sources.

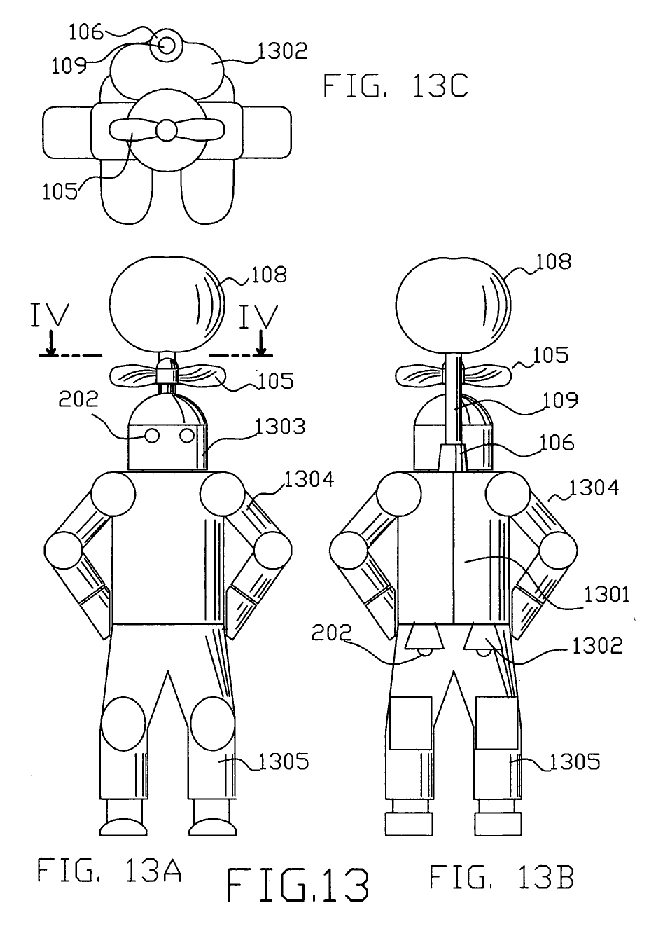

FIG. 13 comprises three views: FIG. 13A and FIG. 13B, illustrating external views, and FIG. 13C, illustrating an upper section view through the plane IV-IV in FIG. 13A, of another alternate embodiment of the combined portable fan-candy holder toy resembling an astronaut or a robot with back rockets 1301 into which can be housed the batteries (not shown) and light/sound emission devices 202 conveniently located to resemble the fire jets at the lower nozzles 1302 of the rockets 1301 and in the head 1303 of the figure. The air impeller 105, resembling a propeller, is located above the head 1303 of the figure, attached to the shaft of the motor (not shown), housed within said head 1303, while the stick 109 of a lollipop 108 is inserted into a holding device 106 located on the upper side of the simulated back rockets 1301, and the power switch (not shown) can be operated by pushing down or twisting the lollipop stick 109. The arms 1304 and the legs 1305 can be fixed or articulated to make their positions adjustable at will by the user.

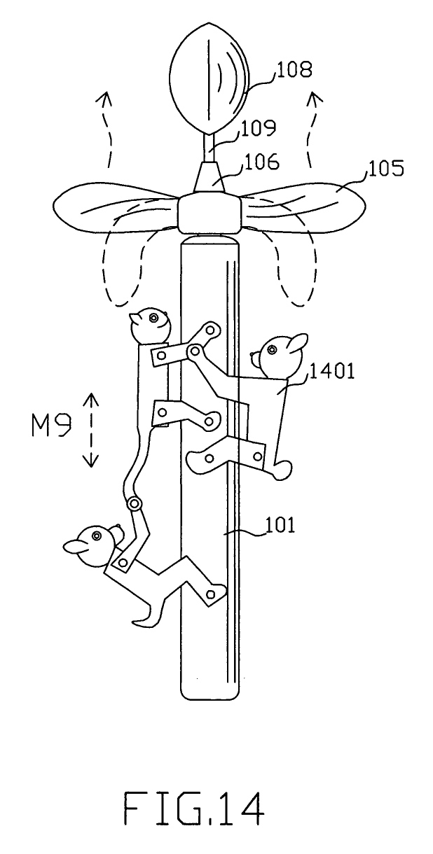

FIG. 14 illustrates an external view of an alternate embodiment of the present invention with a handle 101 housing the batteries and the motor (not shown), provided with exposed flexible fan blades of the air impeller 105, mounted to the rotating stator of the motor, not visible, whose shaft is fixed in a similar way to that previously shown in FIG. 3, so that the lollipop 108 does not rotates, because its stick 109 is inserted to the holding device 106, which in turn is fixed to the stationary upper end of the motor shaft. In addition, in this embodiment the toy includes several conveniently articulated movable FIG. 1401 resembling characters popular among kids, which can be moved manually by the user, pushing any of the figures or shaking the toy, as indicated by the arrow M9.

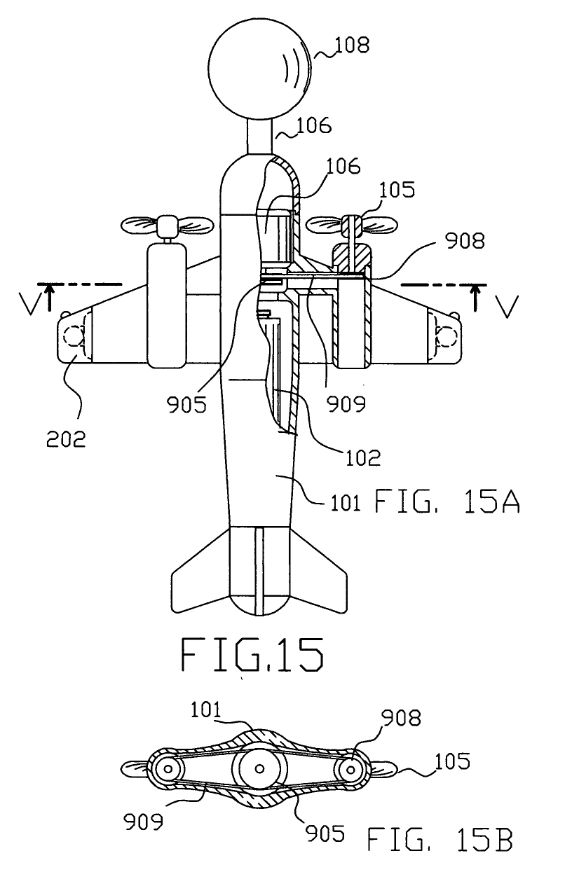

FIG. 15 comprises two partially sectioned views: FIG. 15A, illustrating a general view, and FIG. 15B, illustrating a partial section view through the plane V-V in FIG. 15A, of another alternate embodiment of the present invention resembling an airplane with two air impellers 105 simulating the plane propellers, driven by a motor 104 housed inside the upper portion of the airplane like handle 101. The air impellers 105 and the motor 104 are linked by a belt-pulley transmission, through a belt-pulley transmission integrated by one double driving pulley 905 mounted on the motor shaft, one driven pulley 908 mounted on the shaft of each air impeller shaft, and linked by rubber band belts 909. The toy can be provided with several light emission devices 202 at the tip of the wings, as well as with a sound emission unit resembling the sound of airplane motors. This embodiment, is provided with a male holding device 106 protruding from the front end, to which is attached a stick free candy 108, and the toy may be activated by an appropriate switch (not shown), operated through the holding device 106.

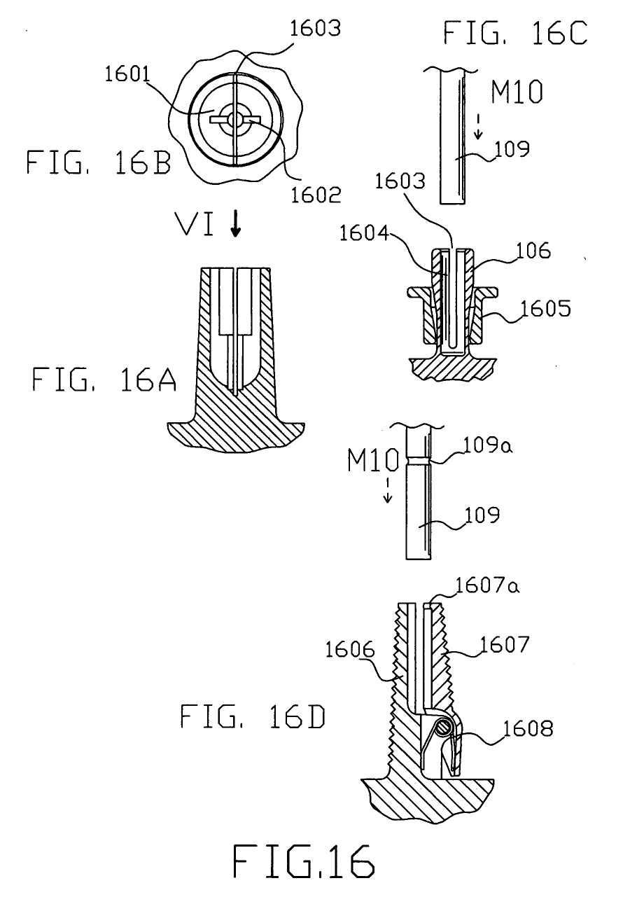

FIG. 16 comprises four views: FIGS. 16A through 16D, illustrating several magnified section views of different alternate configurations that can be used as candy holding devices for combined portable fan-candy holder toy embodiments.

FIG. 16A illustrates an axial section view of a simple slotted candy holding device, of female design, to insert into it the stick of lollipops, popsicles, or other confectioneries, using cylindrical or flat solid sticks, depending solely upon the resilient properties of the material.

FIG. 16B shows an upper view of the candy holding device as indicated by the arrow VI in FIG. 16A, illustrating the configuration of cylindrical stepped holes 1601, the flat groove 1602 intended for flat sticks, and the slot 1603 to provide the required elasticity to the holding device.

FIG. 16C illustrates another possible configuration of candy holding device, in which a cylindrical socket 1604, provided with a slot 1603, has a conical outer surface on which slides an independent bushing 1605, which presses the socket inwardly when is moved upward, securely holding the lollipop stick 109 partially shown above, after its inserted into the holding device as indicated by the arrow M19.

FIG. 16D illustrates another possible embodiment of the holding device, comprising one fixed part 1606 and one articulated part 1607, resembling a crocodile's jaws, being the movable part pressed inwardly by the spring 1608, and provided with a protruding edge 1609 which engages into the groove 1610 on the candy stick 109 partially shown above, when it is inserted, to lock it in place as indicated by the arrow

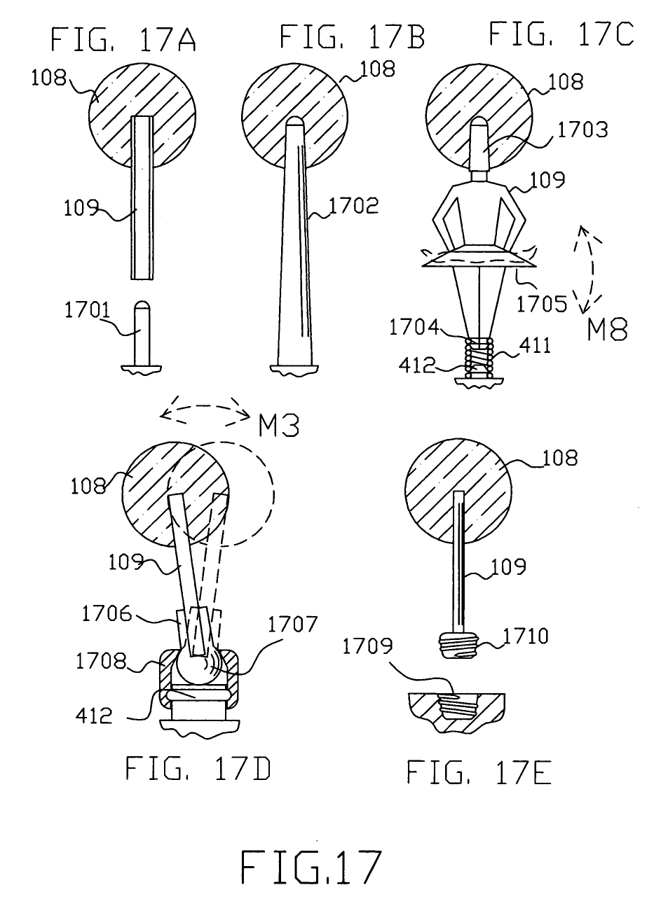

FIG. 17 comprises five views: FIGS. 17A through 17E, illustrating several views of some different configurations of lollipops and candy holding devices for the portable fan-candy holder object of the present invention.

In FIG. 17A is shown a holding device of male type consisting in a simple cylindrical stem 1701 to which can be securely attached a hollow stick 109 of a lollipop 108 shown above.

In FIG. 17B is shown a holding device of male type, consisting in a conical stem 1702 to which can be securely attached a candy 108 without stick, provided with a properly configured assembling hole.

In FIG. 17C is shown a more elaborated holding device resembling the figure of a dancing doll with its upper end or elongated neck 1703 with conical shape onto which is securely attached a candy 108 conveniently designed, resembling the head of the doll, while the lower end 1704 of the holding device is inserted into a helical spring 411 which in turn is securely attached to a short stem 412 protruding from the upper part of the portable fan chamber (not shown). In this embodiment, the skirt 1705 of the doll is made of flexible fabric and undulates, as indicated by the arrow M8, under the action of the air stream coming up from the portable fan below (not shown).

In FIG. 17D, is shown a holding device of female type consisting in a sort of articulated joint, comprising a socket 1706 with its lower end in the form of a sphere 1707, which is held against the upper top of a short stem 412 by means of a hollow cap 1708 properly configured to allow the angular movement, indicated by the arrow M3 of the socket 1706, into which is securely inserted the stick 109 of a lollipop 108, showing an alternate possible position in dotted lines.

In FIG. 17E is shown another possible embodiment of holding device of female type, consisting in a threaded conical hole 1709, inside which can be screwed the stick 109 of a lollipop 108, provided with a special male threaded end 1710.

It would be obvious to one skilled in the art that the air impeller can be of diverse kind, not only of axial type as shown in the figures, but also of centrifugal type. In addition, the power can be supplied not only from electric batteries but also by hand, through levers, rack and pinion and flywheel mechanisms, or from any other mechanical power system such as windings, etc.

Furthermore, the air stream can be provided from small-pressurized containers, rechargeable or disposable, filled with compressed air or any other appropriate gas, which may be sent directly toward the user or to any suitable pneumatic device, which in turn drives an air impeller.

It is also obvious that the air stream may be oriented by means of deflectors and/or conveniently located ducts.

The transmission mechanisms used to drive the fan and all kind of motion, can be provided optionally with a friction coupling that functions also as a sort of torque limiting clutch, which slips relatively easy in case that the moving parts are jammed or blocked.

Finally, when used, the illuminating devices can also be placed behind the air impeller in a manner that allows the light to be alternately blocked and let thru, when the impeller rotates, producing interesting light effects.

The above description is illustrative and not restrictive. The true scope and spirit of the invention resides in the appended claims and their legal equivalents, rather than in the given examples. Modifications and variations on the embodiments described, or known to those skilled in the art, may be made within the scope of the invention as defined by the appended claims.

1. A combined portable fan-candy holder toy comprising:
a portable fan including at least one air impeller driven by an appropriate source such as, but not limited to, a battery powered electric motor, conveniently encased within an appropriate body of suitable materials;
and one or more candy holding devices,
being the purpose of said holding devices to hold one or more candies, securely attached to be sucked or licked by the user, while the portable fan sends a gentle and pleasant breeze, preferably toward the user's face, for his/her amusement and joy.

2. A combined portable fan-candy holder toy as defined in claim 1, wherein the candies are common lollipops whose sticks are inserted into the holding device which has at least one element with the configuration of a hollow socket conveniently dimensioned and conformed to retain the lollipop securely held during its consumption by the user.

3. A combined portable fan-candy holder toy as defined in claim 1, wherein the candy holding device has at least one element with the configuration of a protruding stem properly shaped and dimensioned to securely hold the attached candies, which are similar to those used in lollipops, but provided with a matching hole to engage said stem, instead of a stick like common lollipops or are lollipops with an especially designed hollow stick to fit said stem.

4. A combined portable fan-candy holder toy as defined in claim 1, wherein the candy holding device supports any type of confectionery such as, but not limited to, lollipops, candies, popsicles and ice cream bars.

5. A combined portable fan-candy holder toy as defined in claim 1, wherein the holding device is provided with movable parts, spring loaded or not, to function as a locking mechanism to lock and further secure the stick of the held lollipops.

6. A combined portable fan-candy holder toy as defined in claim 1, wherein the candy holding device is conveniently located anywhere on the embodiment of the toy, either as a rigid fixture or mounted through a movable coupling to allow said holding device to rotate, swivel and/or slide, adjusting the position and the angle at which the lollipops or other confectioneries are held.

7. A combined portable fan-candy holder toy as defined in claim 1, wherein the holding device is provided with different kind of motions by means of appropriate mechanisms driven by hand or conveniently linked to the driving motor of the fan, to transmit such movements to the held lollipop further increasing the user's amusement.

8. A combined portable fan-candy holder toy as defined in claim 1, wherein the air impelling elements are oriented to a certain fixed angular position in relation to the handle portion of the holder being the orientation of said air impelling elements either fixed or adjustable.

9. A combined portable fan-candy holder toy as defined in claim 1, wherein the fan is also capable of free and/or driven motion such as, but not limited to, rotation or oscillation around a pivot and/or linear motion, either manually or by means of suitable transmission mechanisms conveniently linked to the driving motor of the fan.

10. A combined portable fan-candy holder toy as defined in claim 1, wherein the direction of the airflow is controlled by means of suitable fixed and/or adjustable air flow deflectors or ducts.

11. A combined portable fan-candy holder toy as defined in claim 1, wherein the air impelling elements consist of, but are not limited to, axial or centrifugal air impellers.

12. A combined portable fan-candy holder toy as defined in claim 1, wherein the rotating speed of the air impelling elements is varied by means of, but not limited to, rheostats, resistors, and/or other suitable devices.

13. A combined portable fan-candy holder toy as defined in claim 1, wherein the air impelling element is driven manually or mechanically by winding, twisting, compressing, stretching, or bending suitable elastic elements.

14. A combined portable fan-candy holder toy as defined in claim 1, wherein the release of pressurized air or other suitable gas from an appropriate container produces the desired air flow directly or drives an actual air impelling element by means of any suitable pneumatic device.

15. A combined portable fan-candy holder toy as defined in claim 1, wherein the rotating air impelling elements are conveniently unbalanced to produce a vibrating effect on the held candies, what, in the case of two or more candies placed closely together, induce a clapping action between them.

16. A combined portable fan-candy holder toy as defined in claim 1, which is provided with a reservoir suitable to contain liquid such as water, soft drinks and juices, to be consumed by the user and/or a cooling element to cool down the flowing air.

17. A combined portable fan-candy holder toy as defined in claim 1, which is provided with a compartment suitable to store and/or dispense objects such as, but not limited to, spare candies or any other type of confectioneries, and/or spare batteries.

18. A combined portable fan-candy holder toy as defined in claim 1, which is provided with a fixed or detachable base to allow said toy to stand firmly and stable on a supporting surface.

19. A combined portable fan-candy holder toy as defined in claim 1, which is provided with flexible elements made of suitable materials, properly configured, located and attached, that wave under the action of the air flow, displaying colors and glowing effects to add to the user's amusement.

20. A combined portable fan-candy holder toy as defined in claim 1, wherein sound and/or light emission devices, are conveniently mounted anywhere on the toy, enhancing its amusing effect.

21. A combined portable fan-candy holder toy as defined in claim 20, wherein the light emission devices, such as, but not limited to, L.E.D.'s and light bulbs are complemented with light conducting, refracting or reflecting elements, colored translucent lenses, glowing materials or any combination of them, conveniently mounted anywhere on the toy for decorative purposes, enhancing its amusing effect.

22. A combined portable fan-candy holder toy as defined in claim 20, wherein the sound and light emission devices are powered either by independent power sources such as, but not limited to, batteries or capacitors, or by the main power supply, and controlled by any suitable type of switch.

23. A combined portable fan-candy holder toy as defined in claim 1, which is built as a whole sealed unit with non-replaceable batteries.

24. A combined portable fan-candy holder toy as defined in claim 1, which is constructed as a watertight unit employing proper designs and suitable sealing elements.

25. A combined portable fan-candy holder toy as defined in claim 1, which is built as a reusable device, provided with replaceable batteries, removable cover, and a suitable switch conveniently located.

26. A combined portable fan-candy holder toy as defined in claim 1, which is provided with a necklace to hang it around the neck.

27. A combined portable fan-candy holder toy as defined in claim 1, which is provided with an appropriate cover to protect the candy when it is not being consumed.

28. A combined portable fan-candy holder toy as defined in claim 1, which features attractive shapes and colors, and/or is provided with additional moving parts as well as animated figures for decorative purposes.
